(19) United States
(12) Patent Application Publication
(10) Pub. No.: US 2002/0126902 A1
(43) Pub. Date: Sep. 12, 2002

(54) Character information collating correction apparatus

(75) Inventors: Tetsuya Onishi, Tokyo (JP); Youji Yamamichi, Tokyo (JP); Yuji Komiya, Kanagawa (JP)

Correspondence Address: FRISHAUF, HOLTZ, GOODMAN,, LANGER & CHICK, P.C., 767 Third Avenue - 25th Floor, New York, NY, 10017-2023, US

(73) Assignee: Konica Corporation, Tokyo (JP)

(21) Appl. No.: 10/085,263

(22) Filed: Feb. 27, 2002

(30) Foreign Application Priority Data
Mar. 8, 2001 (JP) 065005/2001
Mar. 8, 2001 (JP) 065006/2001
Oct. 31, 2001 (JP) 334698/2001

(51) Int. Cl. G06K 9/68

(52) U.S. Cl. 382/219

(57) ABSTRACT

A character information collating apparatus, comprises an inputting section to input image data and a character information data as a data set; an information memorizing section to memorize a plurality of data sets, wherein the plurality of data sets include a plurality of different character information data; and a retrieving section to retrieve the plurality of data sets memorized in the information memorizing section. When the inputting section inputs a new data set including new image data and a new character information data and the retrieving section judges that the plurality of data sets include the same character information data as the new character information data, the new data set is correlated with the data set including the same character information data memorized in the information memorizing section.

### BACKGROUND OF THE INVENTION

The present invention relates to a character information collating correction apparatus, and more in detail, to an apparatus by which the character information extracted from the image data including an character image in an image by the character recognition, and the image data are made to correspond to each other, and are stored. As one of its application fields, for example, in a field relating to an image recording and reproducing apparatus, and specially, the apparatus by which the image data and the character information supplied to the apparatus in which a medical image information is recorded and reproduced, are made to correspond to each other, and stored, and the character information correction is conducted, is listed.

For example, in the medical image obtained by, for example, a MRI (magnetic resonance imaging) apparatus or a CT (tomography) apparatus, the character image such as a patient ID, and patient name, is recorded in the medical image as a portion of the image data.

Accordingly, generally, the patient ID is extracted from the image as the character information, and stored together with the image information as the character information.

From such the recognition result of the character image stored in the image, the search is conducted on the character information data base, and the other information is added on the base of the search result, and it is transmitted to a filing apparatus.

In the image filing apparatus according to the DICOM which is a medical network standard, in order to prevent the alteration, there are many apparatus structured in such a manner that, not only for the image data, but also for the information of the character information recorded corresponding to the image data, after it is registered once, in order to change a content, a complicated operation is required for the operator (user).

In the case where the character information recognized by the character image recognition is added for each data, when a plurality of image data correspond to the same character information, the plurality of image data are sent as the separate data. In this status, in a case of a plurality of image data according to the same inspection, in the filing apparatus, these data are treated as the data of the separate inspection.

When the data of the same character image recognition result are only collected, in the plurality of image data, to the data whose character image recognition is succeeded, the same character information is affixed, and collected. However, when, in the plurality of image data, there is the data which is failed in the character recognition or search-collation, for the failed portion, the user corrects that and it is sent later. Accordingly, there is a problem that the data which succeeds in the search-collation and the data which fails in that and the user corrects later, are sent as the separate data.

Further, reversely to the above description, when the same character information is affixed to the data whose character image recognition is succeeded, and to the data which fails and the user corrects that later, although, actually, it is according to the separate inspection, the disadvantage that it is treated as the same inspection on the filing apparatus side, is also considered.

In view of these problems, the present invention is attained, and the first object of the present invention is to provide a character information collating correction apparatus by which, even when the data is sent to the filing apparatus at separate timings, the image data and character information can be collated and corrected so that the image of the same inspection of the same patient can be correctly treated and correctly filed.

In this connection, when, in the first-aid patient, or the introduced patient, the patient information is not yet registered in the character information data base, it is not necessary that the character information data base is searched. However, in the case of the apparatus by which the character information data base is automatically searched, it takes a long time because the search and that result are compared to each other, and the image can not be seen at once. However, actually, there is a requirement to want to see the image at once.

When, in the first-aid patient, or the introduced patient, the patient information is not yet registered in the character information data base, any of character information, for example, the patient ID is surely appropriately attached and sent to the image filing apparatus. In the case of the above-described patent, when the patient ID is unexpectedly registered already in the character information data base, the wrong information of the inspection result is affixed, and sent.

In view of such the problems, the present invention is attained, and the second object of the present invention is to provide a character information collating correction apparatus by which, in the case of the first aid patient, the information of the ID of another patient is not falsely affixed.

### SUMMARY OF THE INVENTION

The first object can be attained by the following ((1) to (11)) structures.

(1) In an apparatus having a means for inputting the image data and character information, the information memory means for storing the information of a pair of the image data and character information, and an information search means (or an information retrieving means) for searching the information of the pair of the image data and character information from the information memory means, and when it is found that the new image data and character information exist already in the information memory means by the information search means, the new image data and character information are made to correspond to the pair of the image data and character information existing already, as the same pair.

When the apparatus is structured as described above, when the data is the image data and character information existing already, by making them correspond to each other, as the same pair as the pair of the image data and character information existing already, there is an effect that the search and reproduction can be effectively conducted.

(2) The information memory means stores the image data and character information itself, and the information search means can search the image data and character information itself in the information memory means.

When the apparatus is structured as described above, the search can be conducted including also the image data.

(3) The input character information is the character information extracted by the character recognition from the image data including the character in the image.

When thus structured, the character extracted from the character recognition means can be used as the character information.

(4) An apparatus has a means for searching the input character information from the character information data base having many number of character information, a comparison means for comparing the character information with the character information obtained from the character information data base, and a determination means for determining the character information according to the comparison result by the comparison means.

When thus structured, the inputted character information and the character information from the data base are compared to each other, and the character information can be determined.

(5) An apparatus has an operation means by which the operator operation-inputs the data, and only relating to the image data and character information on which the operator conducts correction-operation, the image data and character information are made to correspond to the image data and character information, as the same pair as the pair of the already existing image data and character information.

When structured as described above, only relating to the operator corrected image data and character information, these can be made to correspond to a pair of the already existing image data and character information.

(6) A character information collating correction apparatus into which the image data and character information are inputted, and which has a function to correct the character information, and has an information memory means for storing the information of a pair of the image data and character information, an information search means for searching the information of the pair of the image data and character information stored in the information memory means, and by the search by the information search means, when it is found that the inputted image data and character information are the generated ones by the same inspection as the one already existing in the information memory means, a determination means for making the pair of the inputted image data and character information correspond to it, as the same pair as the pair of the image data and character information existing in the information memory means.

In the present invention, when it is found that the inputted image data and character information are the generated ones by the same inspection as the one already existing in the information memory means, the pair of the inputted image data and character information is made to correspond to the pair, as the same pair as the pair of the image data and character information existing in the information memory means.

That is, when it is found that it is the same inspection as the pair of the already existing image data and character information, by making them correspond to the pair, as the same pair as the pair of the existing image data and character information, there is an effect that the search and reproduction can be effectively conducted on the filing apparatus side.

(7) A character information collating correction apparatus into which the image data and character information are inputted, and which has a function to correct the character information, and the apparatus has: an information memory means for storing the information of a pair of the image data and character information; an information search means for searching the information of the pair of the image data and character information stored in the information memory means; and by the search by the information search means, when it is judged that the inputted image data and character information are the same as already existing ones in the information memory means, and when they are inputted just before or just after the ones already existing in the information memory means, a determination means for making the pair of the inputted image data and character information correspond to the pair, as the same pair as the pair of the image data and character information existing in the information memory means.

In this invention, when the inputted image data and character information are judged as the same as the ones already existing in the information memory means, and they are ones inputted just before or just after the ones already existing in the information memory means, the pair of the inputted image data and character information is made to correspond to the pair, as the same pair as the pair of the image data and character information existing in the information memory means.

That is, when it is found that it is the same patient and continuously inputted data as the pair of the already existing image data and character information, by making it correspond to the pair, as the same pair as the pair of the existing image data and character information, there is an effect that the search and reproduction on the filing apparatus side can be effectively conducted.

(8) A character information collating correction apparatus into which the image data and character information are inputted, and which has a function to correct the character information, and the apparatus has: an information memory means for storing the information of a pair of the image data and character information; when a pair of the image data and character information is inputted, an information search means for comparing it to ones which is the pair of just before or just after the inputted pair and stored in the information memory means; and by the comparison by the information search means, when the inputted image data and character information are judged as the same as already existing ones in the information memory means, a determination means for making the pair of the inputted image data and character information correspond to the pair, as the same pair as the pair of the image data and character information existing in the information memory means.

In this invention, when the pair of the image data and character information is inputted, a pair just before or just after the inputted pair, is compared to the one stored in the information memory means, and when the inputted image data and character information are judged as the same as ones already existing in the information memory means, the inputted image data and character information are made to correspond to the pair, as the same pair as the pair of the image data and character information existing in the information memory means.

That is, when it is found that it is the same patient and continuously inputted data as the pair of the already existing image data and character information, by making that correspond to the pair, as the same pair as the pair of the existing image data and character information, there is an effect that the search and reproduction can be effectively conducted on the filing apparatus side.

(9) In the structures of (6) to (8), the character information to be inputted is the character information extracted by the character recognition from the image data including the character in the image.

When structured as described above, a character portion included in the image data is extracted by the already known character recognition means, and can be used as the character information, and the effective processing can be conducted.

(10) In the structures of (6) to (9), an apparatus has: a data base search means for searching the inputted character information from the character information data base in which plural pieces of character information are accumulated; a comparison means for comparing the inputted character information to the search result obtained by the search of the character information data base; and a determination means for determining the character information based on the comparison result by the comparison means.

In this invention, when the image is photographed, the character information data base in which the data is inputted and accumulated, can be effectively utilized, and the correct character information can be simply obtained.

(11) In the structures of (6) to (10), the apparatus has an operation means for inputting each kind of operations, and only relating to the image data and character information on which the correction operation is conducted by the operation means, the pair of the image data and character information is regarded as the same pair as the pair of the already existing image data and character information, and they are made to correspond to each other by the determination means.

In this invention, only relating to the image data and character information on which the correction operation is conducted by the operation means, the correspondence of (6) to (10) is made, and relating to the corrected data on which the correction is conducted by the fail of the character recognition, the data according to the same patient and the same inspection can be correctly made to correspond to each other.

The second object can be attained by the following structures (12) to (15).

(12) In an character information collating correction apparatus which has an means for inputting the image data and character information, and by which the character information is corrected, the apparatus has: a specified character memory means for storing the specified character; a comparison means for comparing the inputted character information with the character information stored in the specified character memory means; and an operation means which is operation-inputted by the operator; and when the character information of the specified character is inputted, the correction operation of the character information from the operation means is waited.

When structured as described above, when the character information of the specified character is inputted, because the correction operation of the character information is automatically conducted, there is no possibility that the information of the ID of another patient is erroneously affixed. Further, the correction can be easily conducted later.

(13) It is the character information which the inputted character information extracts from the image data including the character in the image by the character recognition.

When structured as described above, the character information extracted from the image can be utilized.

(14) The apparatus has: a search means for searching the inputted character information from the character information data base having many pieces of character information; a comparison means for comparing the input character information with the character information obtained from the character information data base; and a determination means for determining the character information based on the comparison result by the comparison means.

When structured as described above, by comparing the input character information with the character information obtained from the character information data base, the character information can be determined.

(15) When the specified character information is inputted, the searching from the character information data base is not conducted, and the correction operation of the character information from the operation means is waited.

When structured as described above, because the searching is not conducted from the character information data base, the processing time can be reduced.

### BRIEF DESCRIPTION OF THE DRAWINGS

FIG. 1 is a block diagram showing the embodiment of structures of (1) to (11) of the present invention.

FIG. 2 is a flow chart showing the structures of (1) to (5) of the present invention.

FIG. 3 is an operation illustration of the structures of (1) to (5) of the present invention.

FIG. 4 is a flow chart showing the operation condition of the structures of (6) to (11) of the present invention.

FIG. 5 is an operation illustration in the structures of (6) to (11) of the present invention.

FIG. 6 is a block diagram showing the structures of; (12) to (15) of the present invention.

FIG. 7 is a flow chart showing an embodiment of the operation of the present invention.

FIG. 8 is an operation illustration of the present invention.

### DETAILED DESCRIPTION OF THE PREFERRED EMBODIMENT

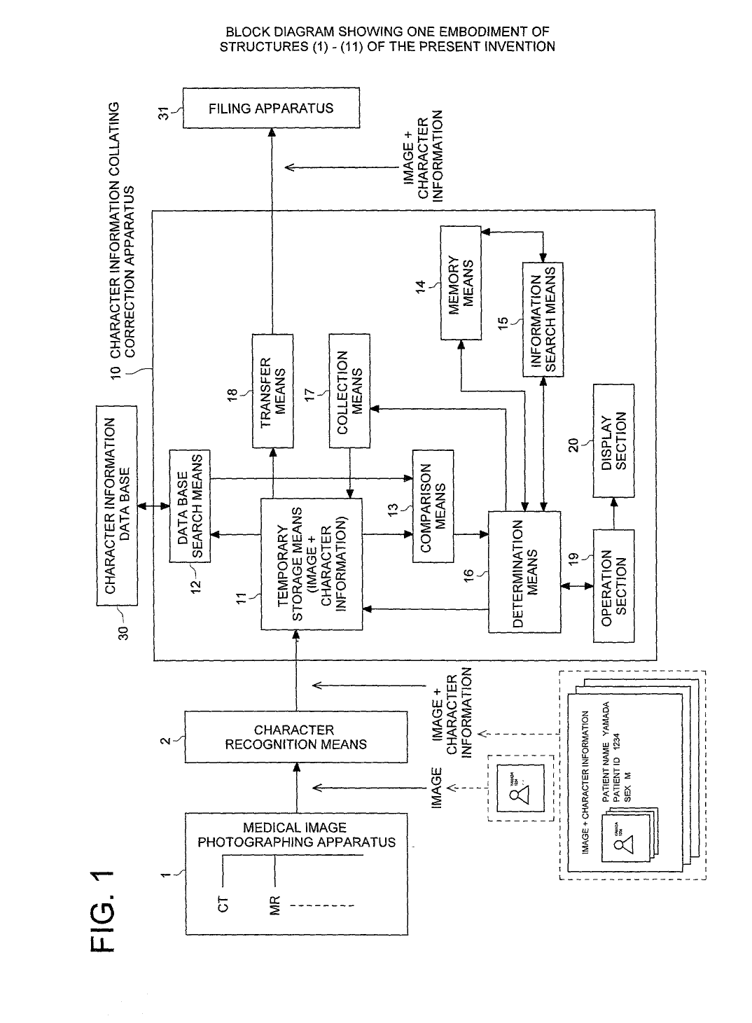

Referring to the drawings, embodiments of the present invention will be detailed below. FIG. 1 is a block diagram showing the embodiment of the structures of (1) to (11) to attain the first object of the present invention. In the drawing, numeral 10 is a character information collating correction apparatus, numeral 30 is a character information data base in which the character information is stored, and numeral 31 is a filing apparatus as an output apparatus. As the filing apparatus 31, for example, a server or viewer is used. The server stores the image information and character information as a pair, and the viewer displays an image. In the character information collating correction apparatus, numeral 1 is a medical image observing apparatus such as a MRI (nuclear magnetic resonance diagnostic apparatus), or CT (tomography apparatus), and numeral 2 is a character recognition means for recognizing the character information from a character image in the image which is an output of the medical image observing apparatus 1. From the character recognition means 2, the image and character information can be obtained. In the drawing, A, B and C show the image in which the character information is stored.

The character information collating correction apparatus 10 receives the image+character information and outputs the image+character information. In the character information collating correction apparatus 10, numeral 11 is a temporary storage means which receives the image +character information and temporarily stores them. Numeral 12 a search means which receives the character information from the temporary storage means 11 and searches the character information of the character information data base 30, and numeral 13 is a comparison means for comparing the character information read from the character information data base 30 with the character information stored in the temporary storage means 11.

Numeral 14 is a memory means for storing a pair of the image data and the character information, numeral 15 is a search means for searching whether the data for the patient is previously outputted, from the memory means 14, and numeral 16 is a determination means which is connected to the comparison means 13, memory means 14 and search means 15, and which determines a pair of the image data and character information. Numeral 17 is a collection means which receives the output of the determination means and collects the pair of the image data and the character information. The collection means 17 reports the result to the temporary storage means 11.

Numeral 18 is a transfer means for transferring the pair of the image data and character information stored in the temporary storage means 11 to the filing apparatus 31, numeral 19 is an operation section as an operation means of the character information collating correction apparatus 10, and numeral 20 is a display section to display the image data and character information. As the operation section 19, for example, a key board or mouse is used, and as the display section, for example, a CRT is used. When the operation of thus structured apparatus is described, it is as follows.

The image outputted from the medical image observing apparatus 1 such as the CT, MRI is inputted into the character recognition means 2. The character recognition means 2 recognizes the patient name or patient ID affixed to the character image in the output image as the character information. As this algorithm of the character recognition, the same one as the conventional technology can be used. When conducting as described above, the character recognized by the character recognition means 2 can be used as the character information. As the result, the image and the character information are outputted from the character recognition means 2. This image+character information are temporarily inputted into the storage means 11 and temporarily stored. Herein, for the character information 1, the image data included therein can also be a case of 1, or a plurality of data.

The search means 12 searches the character information data base 30 on the base of the character information obtained in the character recognition. As the character information, in the case where the search is conducted by the patient ID, when search is conducted by “123”, the other character information than the patient ID “123” can be obtained. That is the patient name, weight, height, birthday, or the distinction of sex.

Next, when the character information is obtained from the character information data base 30, the comparison means 13 compares the character information stored in the temporary storage means 11 to the character information obtained by the search. As the result of the comparison, when it is judged that the character information is the same, by the determination means 16, the character information is determined (overwritten), and stored in the memory means 14. Then, the image data stored in the temporary storage means 11 is read out, and sent to the filing apparatus 31 by the transfer means 18 as a pair of the image data and the character information. Herein, the ‘overwrite’ means, for example, as the patient name, that the whole of romaji, kana, and kanji are written in the character information. When conducting as described above, the inputted character information and the character information from the data base are compared to each other, and the character information can be determined.

By the comparison means 13, the character information of the temporary storage means 11 and the character information obtained by the search are compared to each other, and when they are not the same, the correction of the operator is waited. The operator confirms the image displayed on the display section 20 and inputs the necessary character information from the operation section 19. Further, when necessary, the search is conducted based on the character information, the result is overwritten on the character information, and they are collected together as a pair of the image data and the character information by the collection means 17, and can be transferred from the transfer means 18 to the filing apparatus 31.

Herein, the history of the character information determined by the determination means 16 is stored in the memory means 14, and before transferring to the filing apparatus 31, it is searched by the search means 15 whether there is the same character information in the pair of the image data and the character information to be sent now in the memory means 14. Then, when there is the same character information, the new image data and character information are made to correspond to the pair, as the pair of the already existing image data and character information. When conducting as described above, the search and reproduction can be effectively conducted.

In this case, after the same change as the previous one or necessary change (for example, the serial numbering is conducted) is conducted on an item which is used for collecting as the same thing on the filing apparatus 31 side in the character information, it is transferred from the transfer means 18.

In the case where, for example, a pair of the image data and character information whose patient ID is “001” is sent, when there is the patent ID “001” in the memory means 14, the study UID used for distinguishing unconditionally the inspection in the DICOM standard in the character information is made the same and sent, thereby, it is filed in the pair of the previously sent image data and character information on the filing apparatus 31. For example, in the case where the data whose study UID is “1234” is sent, when there is the data whose study UID is “1234” on the filing apparatus 31 side, the image data is stored in the same study UID area.

Herein, the character information may be the patient name, or other information, or the search may be conducted in a plurality of pairs. The item which is regarded as the same in the filing apparatus 31 may be the other information, or a plurality of pairs.

As described above, according to the present invention, in the case where there is the already existing image data and character information, when they are made to correspond to the pair of the existing image data and character information as the same pair, the search and reproduction can be effectively conducted.

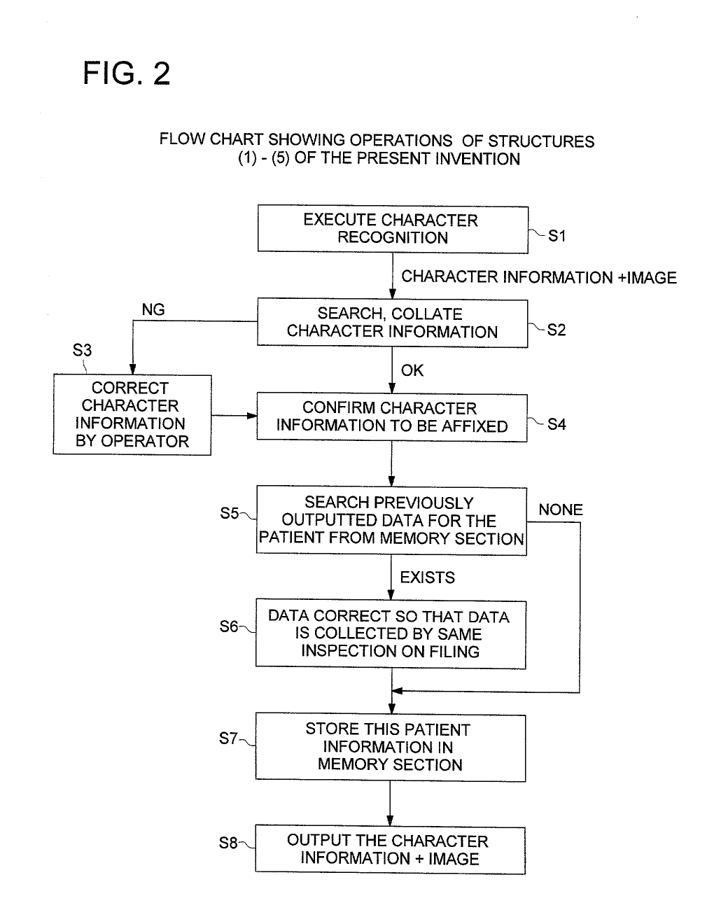

FIG. 2 is a flow chart showing an embodiment of the operation of the structures of (1) to (5) of the present invention. The image data and character information can be obtained by conducting the character recognition (S1). The search means 12 searches the character information data base 30 and conducts the search·collation of the character information (S2). When the result of the collation·search of the character information is NG, the operator corrects the character information (S3). Then, the character information to be affixed, is determined (S4).

Next, it is searched from the memory means 14 whether there is the same data previously outputted for the patient (S5). When there is the data, the data is corrected so that the data is collected together in the same inspection on the filing apparatus (S6). For example, the study UID is made the same. Next, this patient information is stored in the memory means 14 (S7), and the image and character information are outputted from the temporary storage means 11 (S8).

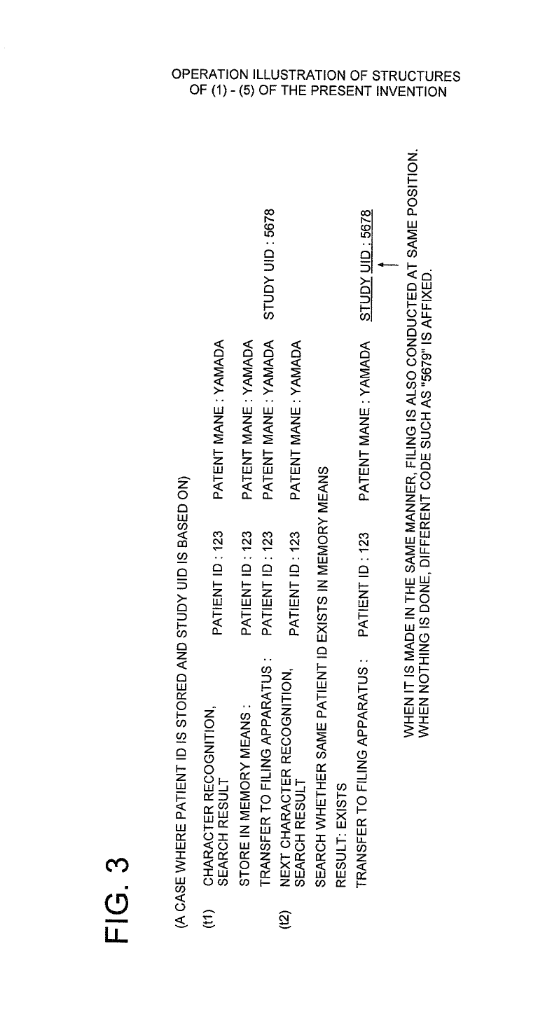

FIG. 3 is an operation illustration of the structures of (1) to (5) of the present invention. Herein, a case where the patient ID is stored, and the study UID is based, will be described below. When, as the result of the character recognition and search at the time t1, the patient ID is “123” and the patient name is “YAMADA”, the patient ID “123” and patient name “YAMADA” are stored in the memory means 14. Next, the patient ID “123” and patient name “YAMADA” are transferred to the filing apparatus side 31. In this case, the transferring is conducted by the study UID “5678”. On the filing apparatus side 31, the patient information (including the image) is stored (filed) by the study UID “5678”.

Next, the result of the next character recognition and the search at the time t2, it is assumed that the patient ID is “123” and the patient name is “YAMADA”. At this time, it is searched whether there is the same patient ID in the memory means 14. As the result of the search, when there is the same patient ID, the patient ID “123”, the patient name “YAMADA” and the study UID “5678” are transferred to the filing apparatus 31. Herein, when it is recognized that the study UID is “5678”, the filing apparatus 31 files the image sent into the memory area of the same study UID “5678”. In this connection, when there is no study UID, as the study UID, the different study UID such as “5671” is affixed.

In the above embodiment, a case where the character information is stored in the memory means 14, is described, but the present invention is not limited to this, and the pair of the image data and the character information is stored in the memory means 14, and the image data and character information itself can be searched.

When conducted as described above, the search can be conducted including also the image data. Further, according to the present invention, the apparatus has the operation section 19 by which the operator operation-inputs, and relating only to the image data and the character information for which the operator conducts the correction operation, the image data and the character information can be made to correspond to a pair of the already existing image data and the character information as the same pair. According to that, only relating to the operator corrected image data and character information, it can be made to correspond to the pair of the already existing image data and character information.

As described above, according to the present invention, the following effects can be obtained.

(1) According to the structure (1), when the data is the already existing image data and character information, because it can be made to correspond to the pair of the existing image data and character information as the same pair, there is an effect that the search and the reproduction can be effectively conducted.

(2) According to the structure (2), the search can be conducted including also the image data.

(3) According to the structure (3), the character extracted from the character recognition means, can be used as the character information.

(4) According to the structure (4), the inputted character information and the character information from the data base are compared to each other, and the character information can be determined.

(5) According to the structure (5), only relating to the image data and character information corrected by the operator, it can be made to correspond to the pair of already existing image data and character information.

As described above, according to the present invention, even when the data is sent at the separate timings, the image of the same patient can be collectively stored, and a character information collating correction apparatus by which the search and reproduction can be efficiently corrected in the filing apparatus, can be provided.

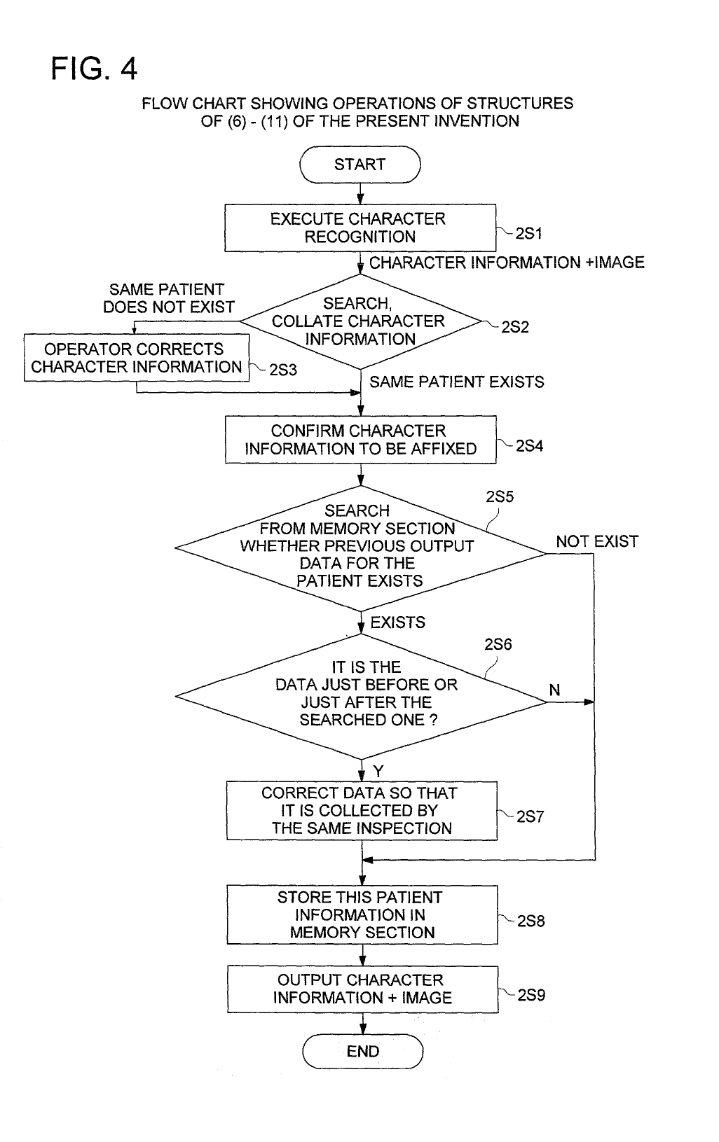

Referring to a flowchart in FIG. 4, when, next, the operation of the embodiment of the structures of (6) to (11) of the present invention will be described, it is as follows.

The image outputted from the medical image photographing apparatus 1 such as CT, MRI, enters into the character recognition means 2. The character recognition means 2 extracts·recognizes the image information such as the patient name, patient ID included in the image as the character information by the method of the already known character recognition. As this algorithm of the character recognition, the same one as the conventional technology can be used. When conducted in this manner, the character recognized by the character recognition means 2 can be used as the character information. As the result of this, the image data and character information are outputted from the character recognition means 2 (2S1).

This image data+character information is entered into the temporary storage means 11 in the character information collating correction apparatus 10 and temporarily stored therein. Herein, to one character information, it can also be a case where the data included therein, is one, or a plurality of data.

The data base search means 12 searches the character information data base 30 on the base of the character information obtained by the character recognition (2S2). Herein, in the character information data base 30, when the photographing is conducted by the medical image photographing apparatus 1, or in the case of the reservation before the photographing, by the in-hospital information system, not shown, each kind of information (patient name, patient ID, weight, height, birthday, the distinction of sex, patient address, photographic method, diagnosis items, or the like) is inputted and accumulated.

Herein, in the case where, as the character information, the search is conducted by the patient ID, when the search is conducted by “123”, the other character information about the patient ID “123”, can be obtained. The other character information is, for example, the patient name, or weight, height, birthday, the distinction of sex, or the like.

Next, when the character information is obtained from the character information data base 30, by the comparison means 13, the character information of the temporary storage means 11 and the character information obtained by the search are compared to each other, when it is judged that they are t not for the same patient (in 2S2, there is no same patient), the correction by the operator is wanted. The operator confirms the image displayed on the display section 20, and the necessary character information is corrected or inputted from the operation section 19 (2S3).

Then, after the correction or input (2S3), by the determination means 16, the character information is determined (2S4), and stored in the memory means 14. Further, as the result of the comparison, when it is judged that the character information is for the same patient, (in 2S2, there is the same patient), by the determination means 16, the character information is determined (overwritten)(2S4), and stored in the memory means 14.

Herein, the overwrite means, for example, as the patient name, whole of the romaji, kana, kanji, that is, including also the item except for the character information obtained from the character recognition, is written. When conducted in this manner, the inputted character information and the character information from the data base are compared to each other, and the character information can be determined.

Herein, the history of the character information determined by the determination means is stored in the memory means 14, and before it is transferred to the filing apparatus 31, it can be searched by the information search means 15 whether the same character information already exists in the pair of the image data and the character information to be sent now, in the memory means 14.

That is, the information search means 15 searches the existence of the previous output to the filing apparatus 31 about the image data+character information of the patient, from the memory means 14 (2S5).

Next, when there is the output to the filing apparatus 31 about the image data+character information of the patient (Y in 2S5, that is, the case where it is judged to be the same), the information search means 15 searches whether the previous output of the patient is for the same inspection, from the memory means 14 (2S6).

Herein, whether the data is for the same inspection, is judged from whether the currently checking image data+character information are the data inputted in the continuous condition to the already outputted image data+character information (that is, whether the already outputted image data+character information and the currently checking image data+character information are the data inputted just before or just after it into the character information collating correction apparatus 10). That is, between the currently checking image data+character information and the already outputted image data+character information, when the image data+character information of the other patient are inputted, it can be judged that it is not the data inputted in the continuous condition, and it is not for the same inspection.

Then, when the image data+character information of the same patient exist, ((exist) in 2S5), and the currently checking image data+character information is the data inputted in the continuous condition to the already outputted image data+character information (Y in 2S6), the data is corrected so that the new image data and character information can be made to correspond to the pair of the already existing image data and character information as the same pair (2S7).

In this case, the item used for collecting as the same data on the filing apparatus 31 side is corrected in the character information so that it becomes the same item as the previous one. That is, the data of the necessary item is corrected so that it can be collected as the same inspection, on the filing apparatus 31 (2S7). For example, the study UID regulated to distinguish the inspection in the DICOM is corrected (set) so that it becomes the same. In this connection, such the data correction may also be the other item to discriminate the inspection.

Next, the patient information is stored (2S8) in the memory means 14, and collected together as the pair of the image data and the character information by the collection means 17, and sent from the transfer means 18 to the filing apparatus 31. That is, the image data stored in the temporary storage means 11 is read out, and sent from the transfer means 18 to the filing apparatus 31 as a pair of the image data and character information (2S9).

In this connection, when the same patient data does not exist in the memory means 14, ((No) in 2S5), or even when the same patient data exists in the memory means 14, when it is not for the same inspection (N in 2S6), the data correction is not conducted, and this patient information is stored in the memory means 14 (2S8), and it is collected together by the collection means 17 as the pair of the image data and character information, and sent from the transfer means 18 to the filing apparatus 31 (2S9).

When the above-described correction (2S7) is conducted, the image data+character information for the same patient and same inspection can be effectively filed, searched and reproduced on the filing apparatus 31 side.

For example, in the case where the pair of the image data and character information whose patient ID is “001” is checked, when the data of the patient ID “001” exists in the memory means 14, when it is found that they are continuously inputted, by sending the study UID used for unconditionally distinguishing the inspection in the DICOM standard in the character information by making it the same, on the filing apparatus 31 side, it is filed as the previously sent pair of the image data and character information. For example, in the case where the data whose study UID is “1234” is sent, when the data whose study UID is “1234” exists on the filing apparatus 31 side, the image data is stored in the same study UID area.

As described above, according to the present embodiment, when the data is compared to the already existing image data and character information, it can be exactly checked that the data is for the same patient and for the same inspection, and when the data is made to correspond to the pair of the already existing image data and character information as the same pair as the pair, the search and reproduction of the data on the filing apparatus 31 side can be effectively conducted.

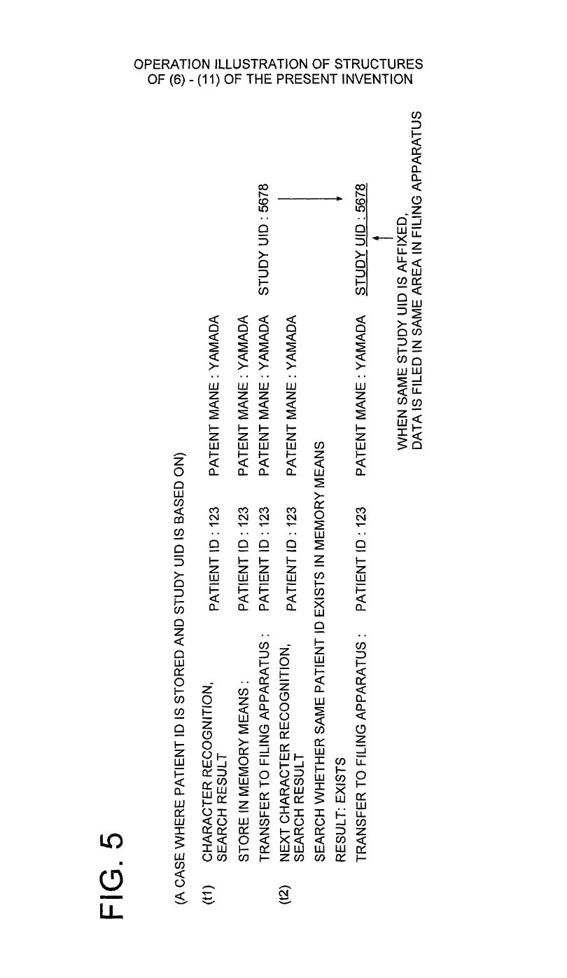

FIG. 5 is an illustration for the operation explanation of the present invention. Herein, a case where the patient ID is stored, and on the filing apparatus side, it is determined whether the same inspection or not on the base of the study UID, will be described below.

When, as the result in which the character recognition and search is conducted at the time t1, the patient ID is “123” and the patient name is “YAMADA”, the patient ID “123” and the patient name “YAMADA” are stored in the memory means 14. Next, the patient ID “123” and the patient name “YAMADA” are transferred to the filing apparatus 31 side. At this time, the transfer is conducted by the study UID “5678”. In the filing apparatus 31 side, the patient information (including the image) is stored (filed) by the study “5678”.

Next, as a result of next character recognition, and search at the time t2, it is assumed that the patient ID is “123” and the patient name is “YAMADA”. At this time, it is searched whether the same patient ID exists in the memory means 14. As the result of the search, when the same patient ID exists therein, and the currently checking image data+character information is the data just before or just after the image data+character information in the memory means 14, after the study UID is corrected to “5678”, it is transferred to the filing apparatus 31.

Herein, when the filing apparatus 31 recognizes that the study UID is “5678”, it is filed as the image sent to the memory area of the same study UID “5678”.

In this connection, even when it is the same patient ID, when it is not the just before data or just after data (when it is not the data continuously inputted into the character information collating correction apparatus 10), because it is another inspection, as the study UID, the different study UID such as “5679” is affixed.

In the above-described embodiment, the case where the character information is stored in the memory means 14, is described, but the present invention is not limited to that, and it can be conducted that the pair of the image and character information is stored in the memory means 14, and the image and character information itself is searched.

Further, in the present embodiment, the apparatus has an operation section 19 by which the operator operation-inputs, and only relating to the image data and character information which is correction-operated by the operator, by checking whether the image data and character information is the same pair as the pair of the already existing image data and character information, the image data and character information can be made to correspond to it. According to this, only relating to the operator corrected image data and character information, by checking whether it is the same inspection as the pair of the already existing image data and character information, it can be made to correspond to that.

For example, when the data in which the character recognition succeeds is successively sent to the filing apparatus side without any delay, and the data in which the character recognition fails, is corrected later with the enough time, that is, when it is sent to the filing apparatus side at the separate timings, this operation is effective.

That is, according to the structure and operation of the above-described embodiment, the effects as described in the following (6) to (11), can be obtained.

In the structure of (6), when it is found that the inputted image data and character information is generated one by the same inspection as the inspection already existing in the information memory means, the pair of the inputted image data and character information is made to correspond to the pair of the image data and character information existing in the information memory means as the same pair. That is, when it is found that the inputted image data and character information is the same inspection as the pair of already existing image data and character information, by making it correspond to the pair of the already existing image data and character information as the same pair, there is an effect that the search and reproduction can be effectively conducted on the filing apparatus side.

In the structure of (7), when it is judged that the inputted image data and character information is the same data as one already existing in the information memory means,(when it is recognized that the same patient data exists), and is the data inputted just before or just after the data already existing in the information memory means, the pair of the inputted image data and character information is made to correspond to the pair of the already existing image data and character information in the information memory means, as the same pair. That is, when it is found that the data is for the same patient as the pair of the already existing image data and character information, and continuously inputted one, by making it correspond to the pair of the already existing image data and character information as the same pair, there is an effect that the search and reproduction can be effectively conducted on the filing apparatus side.

In the structure of (8), when the pair of the image data and character information is inputted, it is compared to the pair just before or just after the inputted pair, and the pair stored in the information memory means, when it is judged that the inputted image data and character information is the same as one already existing in the information memory means, (when it is recognized that the same patient data exists), the pair of the inputted image data and character information is made to correspond to the pair of the already existing image data and character information in the information memory means, as the same pair. That is, when it is found that the data is for the same patient as the pair of the already existing image data and character information, and continuously inputted one, by making it correspond to the pair of the already existing image data and character information as the same pair, there is an effect that the search and reproduction can be effectively conducted on the filing apparatus side.

In the structure of (9), the character information to be inputted is characterized in that the character information extracted from the image data including the character in the image by the character recognition, and when structured in this way, a character portion included in the image data is extracted by the already known character recognition means, and can be used as the character information, and the effective processing can be conducted.

In the structure of (10), the apparatus is provide with a data base search means for searching the character information by the character information data base in which a plural pieces of character information are accumulated, and because the character information is determined on the base of the result in which the inputted character information and the search result obtained by the search are compared to each other, the character information data base which is inputted and accumulated when the image is photographed, can be effectively utilized, and the correct character information can be simply obtained.

In the structure of (11), only relating to the image data and character information on which the correction operation is conducted by the operation means, when the making correspondence of (6) to (10) is made, relating to one which is corrected by the fail of the character recognition, the image data and character information according to the same patient and same inspection can be made to correctly correspond.

As detailed above, according to the present invention, the image data and character information of the same inspection of the same patient can be correctly collated and corrected, and even when it is sent to the filing apparatus side at separate timings, the image of the same inspection of the same patient can be correctly treated, and can correctly filed.

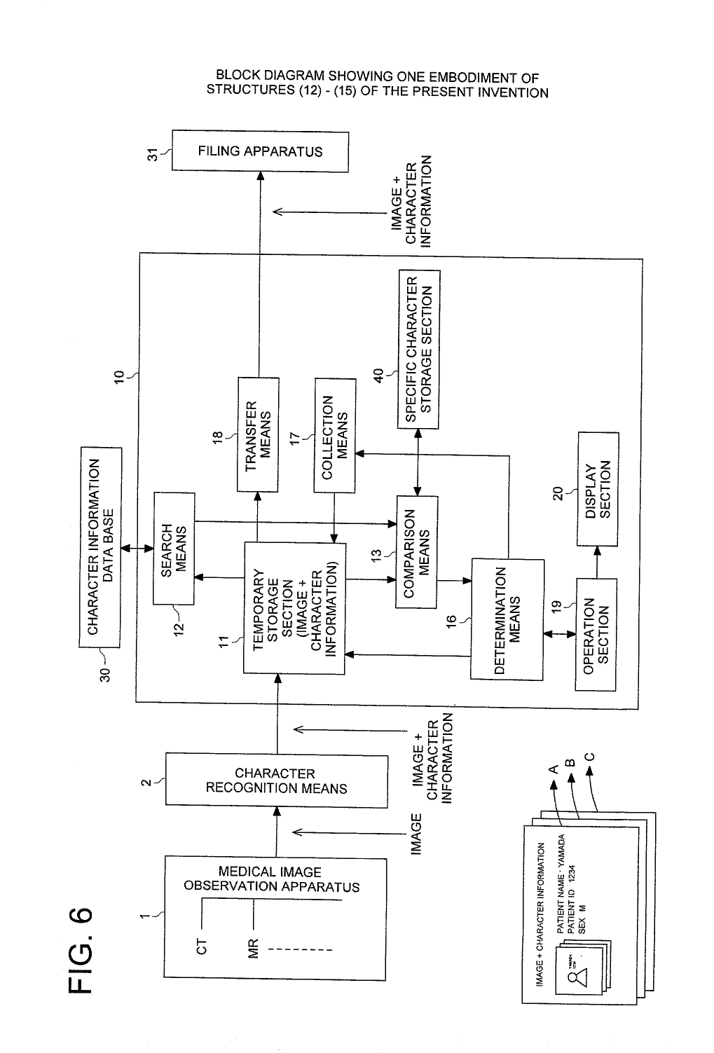

Next, the structures of (12) to (15) to attain the second object will be described. FIG. 6 is a block diagram showing the embodiment of the structures (12) to (15), and because a member of the same reference numeral number as the block diagram of FIG. 1 has the same function, its explanation is omitted. In an embodiment in FIG. 6, a specific character storage section 40 to store the specific character is provided. The operation of the apparatus having such the specific character storage section 40 will be described below.

An image outputted from the medical image observation apparatus 1 such as the CT or MRI, enters into the character recognition means 2. The character recognition means 2 recognizes the patient name and patient ID affixed to the image as the character information. As the algorithm of this character recognition, the same technique as the conventional one can be used. When conducting in this manner, the character recognized from the image by the character recognition means 2 can be used as the character information. As the result, the image and character information are outputted from the character recognition means 2. This image+character information enter into the temporary storage section 11, and temporarily stored therein. Herein, for the character information 1, there is also a case where the image data included therein is one, or plural.

The search means 12 conducts the search of the character information data base 30 based on the character information obtained by the character recognition. In the case where the search is conducted by the patient ID as the character information, when it is searched by “123”, the character information other than the patient ID “123” can be obtained. That is the patient name, weight, height, birthday, sex, or the like.

Next, when the character information is obtained from the temporary storage section 11, the comparison means 13 compares the character information stored in the temporary storage section 11 and the character information obtained by the search to each other. As the result of the comparison, when it is judged that the character information is the same or conforms to the search result, the character information is determined (overwritten) by the determination means 16. Then, the image data stored in the temporary storage section 11 is read out, and is collected together as the pair of the image data and character information by the collection means 17, and transferred to the filing apparatus 31 by the transfer means 18. Herein, the overwrite means, for example, as the patient name, that the whole of the romaji, kana, and kanji, are written. In this connection, the structure of the whole apparatus may also be the structure including the character recognition means 2 or filing apparatus 31. When structured in this manner, the input character information and the character information obtained from the character information data base 30 are compared to each other, and the character information can be determined.

By the comparison means 13, the character information of the temporary storage section 11 and character information obtained by the search are compared to each other, and when they are not the same, the correction of the operator is waited. The operator confirms the image of the image data used for the character recognition, and necessary character information is inputted, and when necessary, the search is conducted on the base of the information, and the result is overwritten on the character information, and they can be transferred to the filing apparatus 31 by the transfer means 18 as the pair of the image data and character information.

In the present invention, as the first aid patient or introduced patient, for the patient who has no data in the data base, or for the patient who has no time to confirm the patient ID, the specific character information is previously stored in a specific character storage section 40. Herein, when the character information previously stored in the specific character storage section 40 is used for the ID of the first aid patient, the specific character information can be recognized. Herein, the specific character information may be a single piece or plural pieces. Further, as the character recognition result, because there is a case where the different kind of plural pieces of character information are sent, it may also be the structure which can be respectively set. For example, as the character recognition result, when the patient ID and patient name are sent, the plurality of specific characters may also be set to the respective data.

The comparison means 13 checks whether the character which is recognized by the character recognition means 2 and inputted from the temporary storage section 11, exists in the specific character storage section 40. When the input character has the same character as the character stored in the specific character storage section 40, it is quickly made to the condition that the operator's correction is waited. When turned to the correction mode, the correct patient information is inputted from the operation section 19. The pair of this patient information and image is transferred from the transfer means 18 to the filing apparatus 31. When the character information is a plurality of kinds of information, by the respective AND or OR condition, the transfer to the condition to wait the correction may be conducted. Further, as the comparison method, it may be further allowed that, not only the entirely the same, but when the characters from the top or the arbitrary serial characters are the same, it may be allowable, and even when only a portion of the character recognition result is correct, it may also be the structure to be quickly corrected.

When thus structured, when the character information of the specific character is inputted, because it automatically enters into the correction operation of the character information, there is no possibility that the information such as the another patient ID is falsely affixed. Further, the correction is easy later.

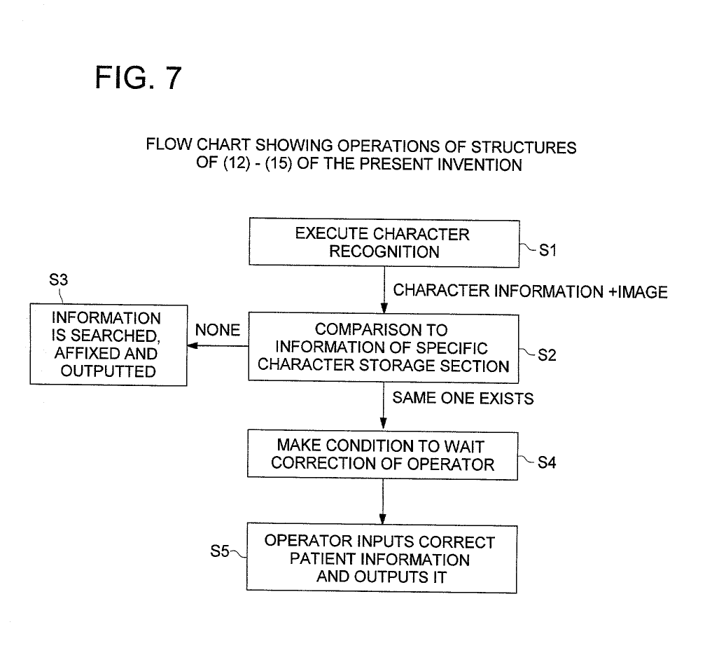

Further, according to the present embodiment, because there is no search from the character information data base, the processing time can be reduced. FIG. 7 is a flow chart showing one embodiment of the operation of the present invention. Initially, the image from the medical image observation apparatus 1 enters into the character recognition means 2, and the character recognition is conducted (3S1). As the result, the image and the character information are outputted from the character recognition means 2, and stored in the temporary storage section 11. The comparison means 13 compares this inputted character information and the character information stored in the specific character storage section 40 to each other (3S2).

As the comparison result, when the inputted character information is not the same as the specific character stored in the specific character storage section 40, the ordinary operation is conducted. That is, the search means 12 searches the character information data base 30 on the base of the character information stored in the temporary storage section 11, and when the same data exists, the comparison means 13 reports it to the determination means 16, the collection means 17 reports the effect that inputted image and character information is collected together to a pair, and is transferred, to the temporary storage section 11, and the image and character information stored in the temporary storage section 11 are transferred from the transfer means 18 to the filing apparatus 31 (3S3).

In step S2, when the input character information is the same as the character stored in the specific character storage section 40, it is made to the condition that the correction of the operator (user) is waited (3S4). In this case, the operator inputs the correct patient information from the operation section 19, and outputs it (3S5). That is, not the specific character, but the correct patient information is inputted. The determination means 16 gives the inputted patient information to the temporary storage section 11, and the patient information hitherto is overwritten, and is set to the correct patient information. As the result, the pair of the image and the correct patient information is transferred from the transfer means 18 to the filing apparatus 31.

As described above, according to the present invention, when the character information of the specific character is inputted, because it automatically enters into the correction operation of the character information, there is no possibility that the information such as another patient ID is falsely affixed, and the correction is easily conducted later. Further, because the search is not conducted from the character information data base 30, the processing time can be reduced.

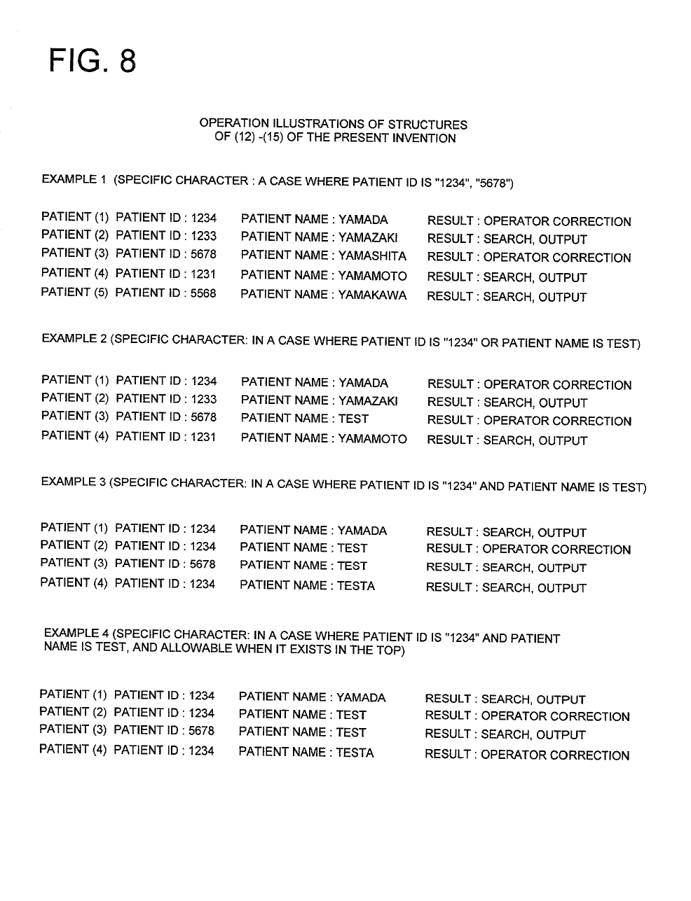

FIG. 8 is an operation illustration of the present invention. Example 1 shows a case where the specific character is the patient ID “1234”, and “5678”. To the patient (1), because the ID is “1234”, the present invention is applied, and becomes the operator correction mode. To the patient (2), because the ID is “1233”, it is not the specific character, but becomes the ordinary search and the output mode. To the patient (3), because the ID is “5678”, the present invention is applied, and becomes the operator correction mode. To the patient (4), because the ID is “1231” and it is not the specific character, it becomes the ordinary search, and output mode. To the patient (5), because the ID is “5568”, it is not the specific character, but becomes the ordinary search and output mode.

Example 2 shows a case where the specific character is OR of the patient ID “1234” and patient name “TEST”. In the case of the patient (1), because the patient ID is “1234”, the present invention is applied, and is turned to the operator correction mode. Because, for the patient (2), the patient ID is “1233” and not “1234”, and the patient name is “YAMAZAKI” and not “TEST”, as the result of the search, it becomes the output mode. For the patient (3), the patient ID is “5678” and not the specific character, but because the patient name is “TEST”, the present invention is applied, and is turned to the operator correction mode. For the patient (4), the patient ID is “1231” and not the specific character, and because the patient name is also “YAMAMOTO”, and not the specific character, it becomes the ordinary search and output mode.

Example 3 shows a case where the specific character is AND of the patient ID of “1234” and the patient name “TEST”. In this case, when the patient ID is “1234” and the patient name is “TEST”, the present invention is applied to it, and is turned to the operator correction mode. One who satisfies this condition, is only the patient (2), and it is turned to the operator correction mode. Because any one of the other patients (1), (2), (3), and (4) does not satisfy the above-described condition, it becomes the ordinary search and output mode.

Example 4 shows a case where the specific character is AND of the patient ID “1234” and the patient name “TEST”. In this case, a case where, when the patient name “TEST” exists in the top of the information, it is allowable, is shown. Because, for the patient (2), the patient ID is “1234”, and patient name is “TEST”, the present invention is applied, and it turns to the operator correction mode. For the patient (4), the patient ID is “1234” and the patient name is “TESTA”, and for the patient name, because the 4 leading characters is “TEST”, the AND condition is satisfied, and the present invention is applied, and it turns to the operator correction mode. Because the patients (3) and (4) do not satisfy the AND condition, it becomes the ordinary search, and output mode.

As detailed above, according to the present invention, the following effects can be obtained. According to the structure (12), because, when the character information of the specific character is inputted, it automatically enters into the correction operation of the character information, there is no possibility that the information such as the ID of the other patient is falsely affixed. Further, the correction is easily conducted later. According to the structure (13), the character information extracted from the image can be used. According to the structure (14), the character information can be determined, by comparing the input character information and the character information obtained from the character information data base to each other. According to the structure (15), because the search is not conducted from the character information data base, the processing time can be reduced.

As described above, according to the present invention, a character information collating correction apparatus in which, in the case of the first aid patient or the like, there is no possibility that the information such as the other patient ID is falsely affixed, can be provided.

What is claimed is:

1. A character information collating apparatus, comprising:
an inputting section to input image data and a character information data as a data set;
an information memorizing section to memorize a plurality of data sets, wherein the plurality of data sets include a plurality of different character information data; and
a retrieving section to retrieve the plurality of data sets memorized in the information memorizing section;
wherein when the inputting section inputs a new data set including new image data and a new character information data and the retrieving section judges that the plurality of data sets include the same character information data as the new character information data, the new data set is correlated with the data set including the same character information data memorized in the information memorizing section.

2. The character information collating apparatus of claim 1, wherein the information memorizing section memorizes image data and character data as the data set and the retrieving section retrieves the image data and the character data in the plurality of data sets.

3. The character information collating apparatus of claim 1, wherein the image data contain a character image data and the character information data are obtained from the character image data by a technique of character recognition.

4. The character information collating apparatus of claim 1, wherein the retrieving section comprises
a character information retrieving section to retrieve the inputted new character information data from the plurality of character information data;
a comparing section to compare the inputted new character information data with a character information data obtained from the plurality of character information data; and
a determining section to determine the character information based on a comparison result by the comparing section.

5. The character information collating apparatus of claim 1, further comprising:
an operating section to correct a data set,
wherein only the data set corrected by the operating section is correlated with as the data set including the same character information data memorized in the information memorizing section.

6. The character information collating apparatus of claim 1, wherein the new data set is memorized in the information memorizing section in a correlated form with the data set including the same character information data.

7. The character information collating apparatus of claim 1, wherein the data set includes an inspection data to identify an inspection conducted for the image data of the data set and the plurality of data sets include a plurality of different inspection data, and
wherein when the retrieving section judges that the new data has the same inspection data as that of the data set including the same character information data, the new data set is correlated with the data set including the same character information data memorized in the information memorizing section.

8. The character information collating apparatus of claim 1, wherein the data set includes a date data at which the image data of the data set is inputted and the plurality of data sets include a plurality of different date data, and
wherein when the retrieving section judges that the new data has date data right before or right after the date data of the data set including the same character information data, the new data set is correlated with the data set including the same character information data memorized in the information memorizing section.

9. A character information collating correcting apparatus, comprising:
an inputting section to input image data and a character information data as a data set;
an information memorizing section to memorize a specific character information data;
a comparing section to compare the character information data with the specific character information data; and
an operating section to operate the data set;
wherein when the comparing section judges that the character information data coincides with the specific character information data, the operation section holds the character information data coinciding with the specific character information data until being corrected by the operating section.

10. The character information collating correcting apparatus of claim 9, wherein the image data contains a character image data and the character information data are obtained from the character image data by a technique of character recognition.

11. The character information collating correcting apparatus of claim 9, further comprising:
a character information retrieving section to retrieve the inputted new character information data from the plurality of character information data;
a comparing section to compare the inputted new character information data with a character information data obtained from the plurality of character information data; and
a determining section to determine the character information based on a comparison result by the comparing section.

12. The character information collating correcting apparatus of claim 11, wherein when the comparing section judges that the character information data coincides with the specific character information data, the operation section holds the character information data coinciding with the specific character information data until being corrected by the operating section without conducting the retrieving.
